(19) United States
(12) Patent Application Publication
(10) Pub. No.: US 2023/0058031 A1
(43) Pub. Date: Feb. 23, 2023

(54) ERRANT ELECTRIC VEHICLE SUPPLY EQUIPMENT DETECTION AND MANAGEMENT

(71) Applicant: Ford Global Technologies, LLC, Dearborn, MI (US)

(72) Inventors: Matthew Roger DeDona, Northville, MI (US); Ryan Hunt, Royal Oak, MI (US); Lila Ghannam, Northville, MI (US); Jered Dziadosz, Novi, MI (US)

(21) Appl. No.: 17/405,674

(22) Filed: Aug. 18, 2021

(51) Int. Cl. B60L 53/16; B60L 55/00; B60L 53/68

(52) U.S. Cl. CPC B60L 53/16; B60L 55/00; B60L 53/68; H02J 7/007182

(57) ABSTRACT

A vehicle includes control pilot circuitry, connected with a charge port, that carries a control pilot signal from electric vehicle supply equipment, and a controller that exits a sleep mode and increases power consumption responsive to changes in the control pilot signal while a plug of the electric vehicle supply equipment is mated with the charge port and an accumulated time associated with the changes remains less than a predefined value.

### TECHNICAL FIELD

This disclosure relates to the charging of automotive batteries.

### BACKGROUND

SAE Surface Vehicle Recommended Practice J1772, SAE Electric Vehicle Conductive Charge Coupler (SAE J1772) is a North American standard for electric vehicle electrical connectors maintained by SAE International. It concerns communication protocol, electrical, performance, and physical requirements for electric vehicle conductive charge systems and associated couplers. This standard intends to define a common electric vehicle conductive charging system architecture, including dimensional, functional, and operational requirements, for vehicle inlets and mating connectors.

IEC 61851 is an international standard for electric vehicle conductive charging systems.

### SUMMARY

A vehicle includes a charge port that receives a plug of electric vehicle supply equipment, control pilot circuitry connected with the charge port and that carries a control pilot signal from the electric vehicle supply equipment, and a controller that exits a sleep mode and increases power consumption responsive to changes in the control pilot signal while the plug is mated with the charge port and an accumulated time associated with the changes remains less than a predefined value, and that remains in the sleep mode regardless of the changes while the plug is mated with the charge port after the accumulated time exceeds the predefined value.

A method includes, by a controller, exiting a sleep mode and increasing power consumption responsive to changes in a control pilot signal from electric vehicle supply equipment while a plug of the electric vehicle supply equipment is mated with a vehicle charge port and an accumulated time associated with the changes remains less than a predefined value, and remaining in sleep mode regardless of the changes while the plug is mated with the charge port after the accumulated time exceeds the predefined value.

A vehicle charge system includes a controller that selectively exits a sleep mode and enters a wake mode based on an accumulated number of changes in a control pilot signal from electric vehicle supply equipment such that the controller remains in the sleep mode regardless of the number of changes after the accumulated number exceeds a predefined value.

### BRIEF DESCRIPTION OF THE DRAWINGS

FIG. 1 is a schematic diagram of electric vehicle supply equipment and a vehicle interface.

FIG. 2 is a block diagram of a vehicle and electric vehicle supply equipment.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Electric vehicles and plug-in hybrid electric vehicles may receive charge via electric vehicle supply equipment that physically connects an off-board charge station to the vehicle via wires. This electric vehicle supply equipment may also physically connect other off-board equipment to the vehicle to permit the vehicle to supply high voltage energy to the other off-board equipment via the wires. Communication between the electric vehicle supply equipment and vehicle, however, may be facilitated via typical wireless—instead of wired—channels. Such communication may be triggered when the electric vehicle supply equipment is plugged into the vehicle.

Electric vehicle supply equipment can operate in an errant manner that may prevent a plug-in vehicle (e.g., a battery electric vehicle or plug-in hybrid electric vehicle) from charging. These electric vehicle supply equipment may develop an errant control pilot signal that prevents the start of charging. While connected to “problematic” electric vehicle supply equipment for an extended time period, the vehicle may experience a depleted 12V battery. This could eventually result in a non-charged high voltage battery. The electric vehicle supply equipment may create this issue by outputting an erratic or non-stable control pilot signal from an internal electronic signal generator manifesting as, for example, frequent or excessive changes in voltage on the control pilot signal. The on-board charger of the vehicle monitors the control pilot signal in sleep mode and will wake up (increase power consumption) when a change of control pilot state occurs. If frequent control-pilot-change-wake-ups never result in a usable energy conversion state, i.e., remain erratic, then the vehicle will deplete its 12V battery. The vehicle owner may not have awareness of this issue, and learn that the vehicle was not charged.

Some examples of errant electric vehicle supply equipment behavior include repeatedly generating a nominal control pilot signal for one second followed by turning off for sixty seconds, repeatedly generating a nominal control pilot signal for three seconds followed by pausing for sixty seconds, and repeatedly generating a digital control pilot signal for five seconds followed by zero for thirty seconds. Similar errors may occur with DC charging stations.

Here, a multi-timer system to monitor “charging time” (Timer 1) and “not charging time” (Timer 2) is considered. Charging time is a consecutive and uninterrupted interval of time. The not charging time is accumulated when the charger is awake, and stored over sleep and power cycles. Both timers are reset when the electric vehicle supply equipment plug is removed from the vehicle. The not charging timer is also reset when the charging time has expired. Before exploring these and other strategies in further detail, an electric vehicle supply equipment/vehicle interface will be discussed.

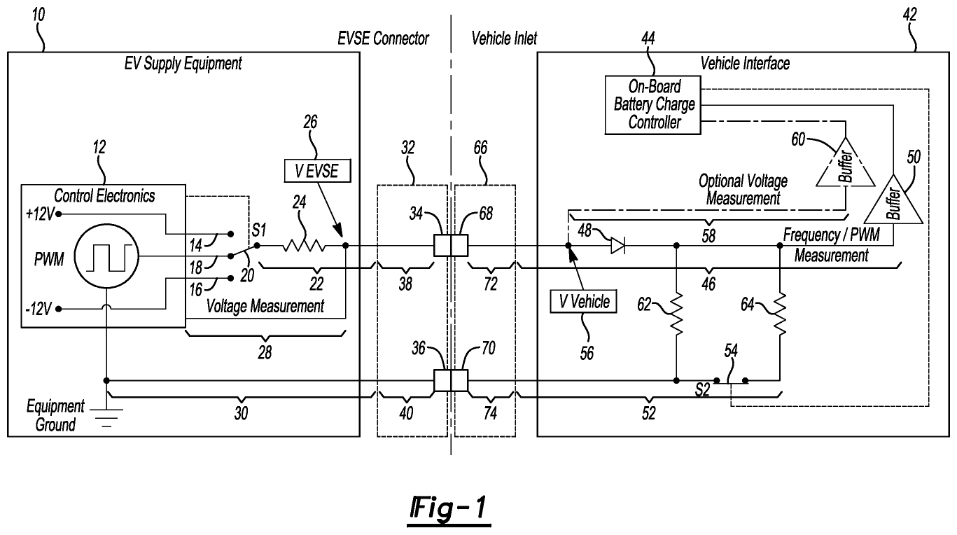

Referring to FIG. 1, certain electric vehicle supply equipment 10 has control electronics 12, a +12V output 14, a −12V output 16, a pulse width modulation (PWM) output 18, a switch 20, a control pilot portion 22, which includes resistor 24, a voltage sensor 26, a voltage sensor line 28, and a ground portion 30, which is grounded. The outputs 12, 14 are connected with +12V and −12V sources, respectively. The PWM output 18 is connected with an oscillator that, in this example, is a 1 KHz oscillator between +/−12V, which is grounded. The switch 20 is electrically connected in series between the control electronics 12 and resistor 24. Depending on the mode in which the electric vehicle supply equipment 10 is operating when plugged in, the switch 20 will either be connected to the +12V output 14 or the PWM output 18. The voltage sensor line 28 electrically connects the control electronics 12 and voltage sensor 26, which is arranged to sense the voltage on the control pilot portion 22 (after the switch 20 and resistor 24) and carry the same to the control electronics 12.

An electric vehicle supply equipment connector 32 includes terminals 34, 36, a control pilot portion 38, and a ground portion 40. The control pilot portion 38 is electrically connected between the control pilot portion 22 and terminal 34. The ground portion 40 is electrically connected between the ground portion 30 and terminal 36.

A vehicle interface 42 includes an on-board charge controller 44, a control pilot portion 46 including diode 48 and buffer 50, a ground portion 52 including switch 54, a voltage sensor 56, a voltage sensor line 58 including buffer 60, and grounding resistors 62, 64. The switch 54 is controlled by the on-board charge controller 44. The voltage sensor line 58 electrically connects the on-board battery charge controller 44 and voltage sensor 56, which is arranged to sense the voltage on the control pilot portion 46 (prior to the diode 48 and buffer 50) and carry the same to the on-board battery charge controller 44. The grounding resistors 62, 64 electrically connect the control pilot portion 46 to the ground portion 52 on either side of the switch 54.

A vehicle charge port 66 includes terminals 68, 70, a control pilot portion 72, and a ground portion 74. The control pilot portion 72 is electrically connected between the control pilot portion 46 and terminal 68. The ground portion 74 is electrically connected between the ground portion 52 and terminal 70.

When the electric vehicle supply equipment connector 32 and vehicle charge port 66 are connected (that is, when the electric vehicle supply equipment 10 is plugged in), the terminals 34, 68 mate, resulting in control pilot portions 22, 38, 46, 72 forming a continuous control pilot line between the control electronics 12 and on-board battery charge controller 44 that carries signals therebetween for measurement and interpretation by the on-board battery charge controller 44. The terminals 36, 70 also mate, resulting in ground portions 30, 40, 52, 74 forming a continuous ground line between the control pilot portion 46 and ground of the electric vehicle supply equipment 10.

Errant electric vehicle supply equipment may be detected through monitoring when charging occurs and when charging does not occur while on-plug. The monitors and timers may be implemented by the on-board battery charge controller 44 and activated when the electric vehicle supply equipment connector 32 is plugged into the vehicle charge port 66. The monitors and/or timers may be selectively deactivated once successful charging is detected or the electric vehicle supply equipment connector 32 is removed as described in more detail below.

Timer 1 monitors continuous charge time and resets to zero when not charging. As mentioned above, when Timer 1 reaches is maximum value, Timers 1 and 2 will reset. That is, charging will continue, but Timer 1 will stop counting. Timer 2 monitors, in this example, not charging time (while the control pilot signal is non-zero but its value does not support charging) and resets when the vehicle supply equipment connector 32 is unplugged or Timer 1 expires. The calibration for Timer 2 can be selected to correspond with the maximum permissible unsupported 12V battery drain during the low power monitoring. For example, assume a 12V load of 5 A for one hour, this represents a 5 amp-hr capacity reduction from a nominal 30 amp-hr 12V battery (less than a 20% capacity loss). Timer 3 monitors the delay time before the on-board battery charge controller 44 goes to sleep once it determines the control pilot signal is no longer present.

All timer values can be calibrated. Timer 1, for example, may have a maximum value of 2 minutes, Timer 2 may have a maximum value of 1 hour, and Timer 3 may have a maximum value of 61 seconds. All timers may reset when the on-board battery charge controller 44 goes to sleep after it determines the control pilot signal is no longer present. For a successful charging event, Timer 1 will expire. A continuous time interval (a calibration) is thus required to declare the charge a success.

Timer 2 will accumulate non-charging time while on-plug, the control pilot signal is present, and the 12V battery is not being charged (e.g., DC/DC converter is disabled). As Timer 2 accumulates, the corresponding 12V battery state of charge decreases. When Timer 2 expires for an unsuccessful charge, the on-board battery charge controller 44 may report an electric vehicle supply equipment alert, log a fault code, and ignore further control pilot signal changes (and thus remain in sleep mode regardless of further control pilot signal changes). Further 12V battery discharge is thus prevented by disabling the control pilot signal monitor. A vehicle ignition key cycle, electric vehicle wakeup, or charge port door open may be required to restart the control pilot signal monitoring. The electric vehicle supply equipment alert can be sent to a customer so that different electric vehicle supply equipment can be selected.

The Timer 2 includes the cumulative on-board wake time and does not include sleep or OFF time while on-plug. Timer 2 accumulates on-board charger awake time when the control pilot signal value does not support active charging. For example, if the control pilot signal indicates pause and remains pause, the on-board battery charger controller 44 will accumulate wake time but not during sleep. The Timer 2 value can be stored in keep-alive-memory when the charger transitions to sleep mode. On charger wakeup from sleep while on-plug, the Timer 2 value is restarted from the stored value.

Timer 3 accounts for detection of an errant electric vehicle supply equipment that transitions to the OFF state and wakes up a short period later. Without Timer 3, the other monitors may reset. This identifies electric vehicle supply equipment with ON-OFF-ON short cycling operation.

Alternatively, Timer 2 may accumulate the number of changes in the control pilot signal while on-plug rather than the cumulative on-board wake time. If the number of changes exceeds some calibratable predefined value (e.g., 50, 100, etc.), operations similar to those described above can be performed. The on-board battery charge controller 44, for example, may remain in sleep mode regardless of the number of changes after the number exceeds the predefined value, etc. Resetting of Timer 2, however, may be the same as described earlier.

In summary, Timers 1 and 3 are used to reset Timer 2. If either of their maximum values is achieved, Timer 2 is reset. Timer 2 is a cumulative timer.

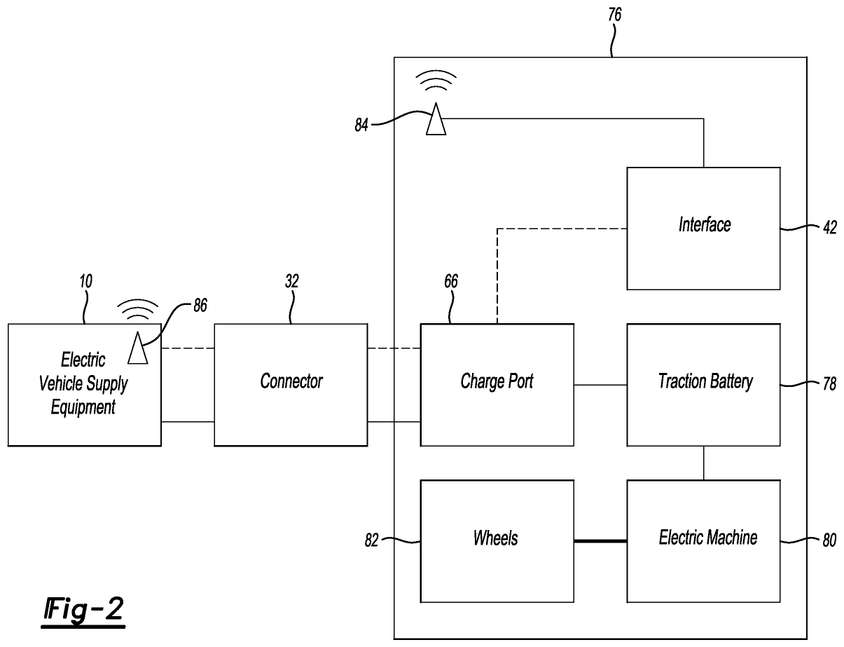

Referring to FIG. 2, a vehicle 76 includes the vehicle interface 42, the vehicle charge port 66, a traction battery 78, an electric machine 80, wheels 82, and a wireless transceiver 84. The traction battery 78 is arranged to provide electrical power to, and receive electrical power from, the electric machine 80. The electric machine 80 transforms electrical power from the traction battery 78 to mechanical power to move the wheels 82. The electric machine 80 also transforms mechanical power from the wheels 82, during regenerative braking, to electrical power for storage in the traction battery 78. The traction battery 78 is also arranged to receive electrical power from the charge port 66 and provide power to the charge port 66.

The vehicle interface 42 can transmit and receive wireless messages, etc., via the transceiver 84.

The electric vehicle supply equipment 10 includes a transceiver 86. The electric vehicle supply equipment 10 can transmit and receive wireless messages, etc., via the transceiver 86.

The dashed line connecting the electric vehicle supply equipment 10, the connector 32, the vehicle charge port 66, and the vehicle interface 42 represents the control pilot line between the electric vehicle supply equipment 10 and the vehicle interface 42. The solid line connecting the electric vehicle supply equipment 10, the connector 32, the charge port 66, and the traction battery 78 represents the wired path over which electric power can be transferred between the electric vehicle supply equipment 10 and the traction battery 78.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a charge port configured to receive a plug of electric vehicle supply equipment;
control pilot circuitry connected with the charge port and configured to carry a control pilot signal from the electric vehicle supply equipment; and
a controller programmed to exit a sleep mode and increase power consumption responsive to changes in the control pilot signal while the plug is mated with the charge port and an accumulated time associated with the changes remains less than a predefined value, and to remain in the sleep mode regardless of the changes while the plug is mated with the charge port after the accumulated time exceeds the predefined value.

2. The vehicle of claim 1, wherein the controller is further programmed to reset the accumulated time to zero responsive to occurrence of a predefined duration of continuous charging.

3. The vehicle of claim 1, wherein the controller is further programmed to reset the accumulated time to zero responsive to the plug being removed from the charge port.

4. The vehicle of claim 1, wherein the controller is further programmed to exit the sleep mode and increase power consumption while the plug is mated with the charge port after the accumulated time exceeds the predefined value responsive to presence of a vehicle activation signal.

5. The vehicle of claim 1, wherein the controller is further programmed to generate an alert after the accumulated time exceeds the predefined value.

6. The vehicle of claim 1, wherein the controller is further programmed to increment the accumulated time while the controller is in a wake mode but not while the controller is in the sleep mode.

7. A method comprising:
by a controller, exiting a sleep mode and increasing power consumption responsive to changes in a control pilot signal from electric vehicle supply equipment while a plug of the electric vehicle supply equipment is mated with a vehicle charge port and an accumulated time associated with the changes remains less than a predefined value, and remaining in sleep mode regardless of the changes while the plug is mated with the charge port after the accumulated time exceeds the predefined value.

8. The method of claim 7 further comprising resetting the accumulated time to zero responsive to occurrence of a predefined duration of continuous charging.

9. The method of claim 7 further comprising resetting the accumulated time to zero responsive to the plug being removed from the charge port.

10. The method of claim 7 further comprising exiting the sleep mode and increasing power consumption while the plug is mated with the charge port after the accumulated time exceeds the predefined value responsive to presence of a vehicle activation signal.

11. The method of claim 7 further comprising generating an alert after the accumulated time exceeds the predefined value.

12. The method of claim 7 further comprising incrementing the accumulated time while the controller is in a wake mode but not while the controller is in the sleep mode.

13. A vehicle charge system comprising:
a controller programmed to selectively exit a sleep mode and enter a wake mode based on an accumulated number of changes in a control pilot signal from electric vehicle supply equipment such that the controller remains in the sleep mode regardless of the number of changes after the accumulated number exceeds a predefined value.

14. The vehicle charge system of claim 13, wherein the controller is further programmed to reset the accumulated number to zero responsive to occurrence of a predefined duration of continuous charging.

15. The vehicle charge system of claim 13, wherein the controller is further programmed to reset the accumulated number to zero responsive to a plug of the electric vehicle supply equipment being removed from a charge port.

16. The vehicle charge system of claim 13, wherein the controller is further programmed to exit the sleep mode and enter the wake mode after the accumulated number exceeds the predefined value responsive to presence of a vehicle activation signal.

17. The vehicle charge system of claim 13, wherein the controller is further programmed to generate an alert after the accumulated number exceeds the predefined value.
